(19) United States
(12) Patent Application Publication
(10) Pub. No.: US 2014/0188511 A1
(43) Pub. Date: Jul. 3, 2014

(54) SYSTEMS AND METHODS FOR STRATIFICATION AND MANAGEMENT OF MEDICAL CONDITIONS

(71) Applicant: GENESIS HEALTHCARE PARTNERS, San Diego, CA (US)

(72) Inventors: Franklin D. Gaylis, San Diego, CA (US); Renee Angeline Calabrese, Escondido, CA (US); Edward Seven Cohen, San Diego, CA (US)

(73) Assignee: GENESIS HEALTHCARE PARTNERS, San Diego, CA (US)

(21) Appl. No.: 14/104,966

(22) Filed: Dec. 12, 2013

Related U.S. Application Data
(60) Provisional application No. 61/736,142, filed on Dec. 12, 2012.

(51) Int. Cl. G06F 19/00

(52) U.S. Cl. CPC G06F 19/322
USPC 705/3; 705/2

(57) ABSTRACT

Automated medical analysis may organize medical data based on disease stage and generate a treatment option based on the disease stage. A server comprising a processor circuit and a database may receive medical data. The processor circuit may identify data indicative of a disease stage within the medical data and store the data indicative of the disease stage in the database. The processor circuit may organize the data indicative of the disease stage based on disease stage. The processor circuit may analyze the data indicative of the disease stage to generate a treatment option based on the disease stage. The processor circuit may cause the treatment option and the organized data to be displayed.

### CROSS-REFERENCE TO RELATED APPLICATION

This application claims the benefit of U.S. provisional application No. 61/736,142, filed Dec. 12, 2012, which is incorporated herein by reference in its entirety.

### BACKGROUND

Health care providers place a high priority on reducing and/or eliminating mistakes to improve patient care. In pursuit of this goal, a variety of possible improvements have been suggested. For example, greater attention to the practice of evidence-based medicine and development of practice standards may reduce medical errors and improve medical care quality.

There is a perception that physicians do not readily embrace change and typically are considered a very independent, autonomous group, which is supported by several studies which demonstrate reluctant implementation of evidence-based treatments throughout the medical field. New knowledge about treatments disseminated passively may have little or no influence on practice patterns. Compliance rates with appropriate care regimens are often low. In many cases, patients may not even receive basic evaluation and treatment consistent with the latest knowledge. Despite this, standardizing care and incorporating evidence-based medical orders can result in significant outcome improvements. Providing evidence-based data to physicians at the point of care (e.g., via Standardized Evidenced Based Medical Orders (SEBMOs) and Computerized Physician Order Entry) may increase physician compliance and thereby improve patient outcomes.

### SUMMARY OF THE DISCLOSURE

Medical analysis methods and systems are described herein. For example, a medical analysis method may comprise receiving, at a server comprising a processor circuit and a database, medical data; identifying, with the processor circuit, data indicative of a disease stage within the medical data; storing, with the processor circuit, the data indicative of the disease stage in the database; organizing, with the processor circuit, the data indicative of the disease stage based on disease stage; analyzing, with the processor circuit, the data indicative of the disease stage to generate a treatment option based on the disease stage; and causing, with the processor circuit, the treatment option and the organized data to be displayed. The medical data may comprise data extracted from an electronic health record (EHR) database and/or data associated with a specific patient which may be received from a client computer via a network. Methods may further comprise extracting, with the processor circuit, the medical data from the EHR database via a network. Methods may further comprise identifying data indicative of a disease stage within the medical data by flagging at least a portion of the medical data for review; and receiving results of a review indicating whether the portion of the medical data is indicative of a disease stage. Methods may further comprise organizing the data indicative of the disease stage based on disease stage by evaluating the data indicative of the disease stage to identify a factor associated with the disease stage. The factor may include test results, indicator levels, radiographic studies, treatment interventions, or a combination thereof. Methods may further comprise analyzing the data indicative of the disease stage to generate a treatment option based on the disease stage by analyzing the factor to identify a treatment option associated with the factor. Methods may further comprise causing the treatment option and the organized data to be displayed by generating a report including the treatment option and the organized data. The report may comprise a disease status snapshot and/or an active surveillance report Methods may further comprise causing the treatment option and the organized data to be displayed by sending the treatment option and the organized data to a client computer via a network. The treatment option may comprise a treatment protocol based on the disease stage. Methods may further comprise grouping, with the processor circuit, a plurality of patients associated with the medical data based on the treatment option and/or the organized data; and storing, with the processor circuit, the grouping in the database.

An example medical analysis system may comprise a database and a processor circuit in communication with the database. The processor circuit may be configured to receive medical data; identify data indicative of a disease stage within the medical data; store the data indicative of the disease stage in the database; organize the data indicative of the disease stage based on disease stage; analyze the data indicative of the disease stage to generate a treatment option based on the disease stage; and cause the treatment option and the organized data to be displayed. The medical data may comprise data extracted from an electronic health record (EHR) database, for example extracted by the processor circuit, and/or data associated with a specific patient which may be received from a client computer via a network. In some systems the processor circuit may be configured to identify data indicative of a disease stage within the medical data by flagging at least a portion of the medical data for review; and receiving results of a review indicating whether the portion of the medical data is indicative of a disease stage. In some systems the processor circuit may be configured to organize the data indicative of the disease stage based on disease stage by evaluating the data indicative of the disease stage to identify a factor associated with the disease stage. The factor may include test results, indicator levels, radiographic studies, treatment interventions, or a combination thereof. In some systems the processor circuit may be configured to analyze the data indicative of the disease stage to generate a treatment option based on the disease stage by analyzing the factor to identify a treatment option associated with the factor. In some systems the processor circuit may be configured to cause the treatment option and the organized data to be displayed by generating a report including the treatment option and the organized data. The report may comprise a disease status snapshot and/or an active surveillance report In some systems the processor circuit may be configured to cause the treatment option and the organized data to be displayed by sending the treatment option and the organized data to a client computer via a network. The treatment option may comprise a treatment protocol based on the disease stage. In some systems the processor circuit may be configured to group a plurality of patients associated with the medical data based on the treatment option and/or the organized data and store the grouping in the database.

### BRIEF DESCRIPTION OF THE DRAWINGS

FIG. 1 is a network according to an embodiment of the invention.

FIG. 2 is a medical care protocol generation process according to an embodiment of the invention.

FIG. 3 is a treatment option generation process according to an embodiment of the invention.

FIG. 4 is a classification and reporting process according to an embodiment of the invention.

FIG. 5 is diagram of prostate cancer progression and recommended options for treatment according to stage as a function of Prostate Specific Antigen (PSA) reflected tumor load according to an embodiment of the invention.

FIG. 6 is a description of prostate cancer staging and the pathologic stage of tumor at each stage according to an embodiment of the invention.

FIGS. 7A-7C are sample reports for patients with specific classifications according to an embodiment of the invention.

FIG. 8 is an active surveillance report according to an embodiment of the invention.

### DETAILED DESCRIPTION OF SEVERAL EMBODIMENTS

Systems and methods described herein may generate data useful for the management of various medical conditions. For example, according to various embodiments described herein, medical conditions may be stratified and managed according to stage. Accurate medical record analysis may be provided at point of care to enable healthcare providers to make evidence-based decisions when providing healthcare to individuals. Improvements in quality of patient care may be realized by providing healthcare providers with evidence-based recommendations in disease management. For example, systems and methods described herein may extract information from electronic health records (EHR) (which may include electronic medical records (EMR)) and import relevant medical information into a separate database; embed knowledge into a point of care database; stratify patients according to disease stage; and/or provide evidence based medical care protocols for medical condition management according to evidence based standards at the point of care.

The systems and methods described herein may comprise one or more computers. A computer may be any programmable machine capable of performing arithmetic and/or logical operations. In some embodiments, computers may comprise processors, memories, data storage devices, and/or other commonly known or novel circuits and/or components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, communication devices, and other terms. Computers may facilitate communications between users, may provide databases, may perform analysis and/or transformation of data, and/or perform other functions. It will be understood by those of ordinary skill that those terms used herein are interchangeable, and any computer capable of performing the described functions may be used. For example, though the terms “database” and “server” may appear in the following specification, the disclosed embodiments may not necessarily be limited to databases and/or servers.

Computers may be linked to one another via a network or networks. A network may be any plurality of completely or partially interconnected computers wherein some or all of the computers are able to communicate with one another. It will be understood by those of ordinary skill that connections between computers may be wired in some cases (i.e. via Ethernet, coaxial, optical, or other wired connection) or may be wireless (i.e. via Wi-Fi, WiMax, cellular, satellite, or other wireless connection). Connections between computers may use any protocols, including connection oriented protocols such as TCP or connectionless protocols such as UDP. Any connection through which at least two computers may exchange data may be the basis of a network.

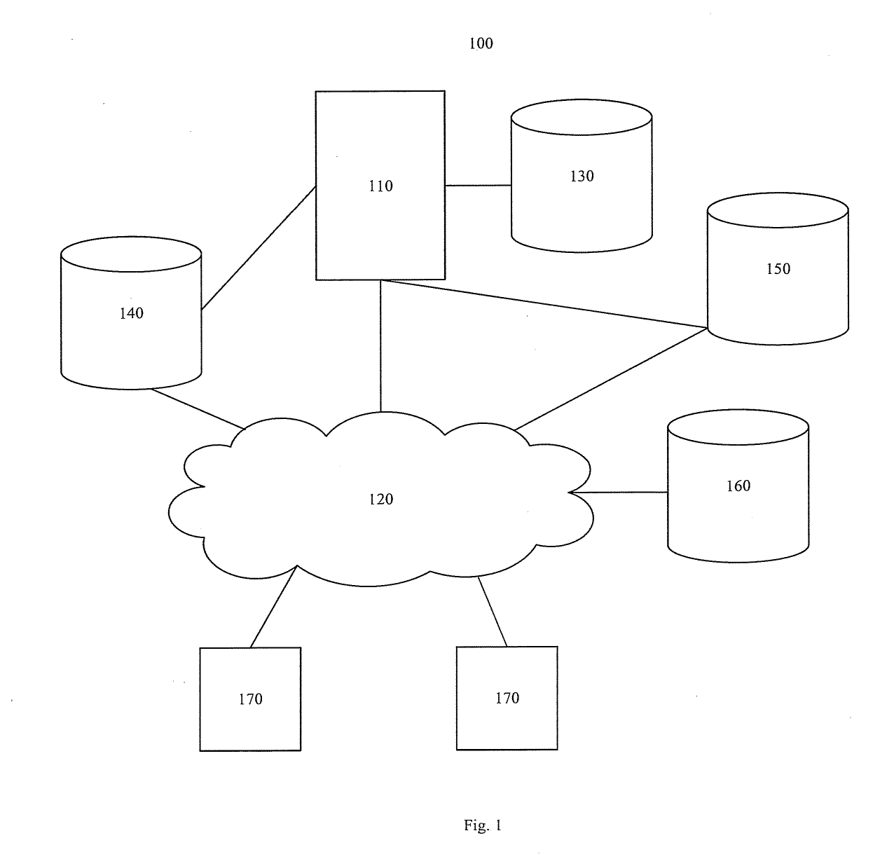

FIG. 1 is a network 100 according to an embodiment of the invention. The network 100 may include one or more computers used to stratify and manage medical conditions as described in greater detail below. The network 100 may include one or more servers 110 which may be configured to perform the medical condition stratification and management. The server 110 may communicate with other computers via the Internet 120 or other communication networks in some embodiments. The server 110 may include and/or be in communication with a local database 130. The server 110 may also communicate with EHR databases 150 and/or other data sources 160, which may be databases linked directly to the server 110 and/or databases accessed via the Internet 120. The server may also communicate with a point of care database 140. One or more client computers 170 may be included in the network 100. For example, these client computers 170 may be physician's computers which may access the server 110 and/or point of care database 140 via the Internet 120 or some other connection. The functions and features of the components shown in FIG. 1 are described in greater detail below.

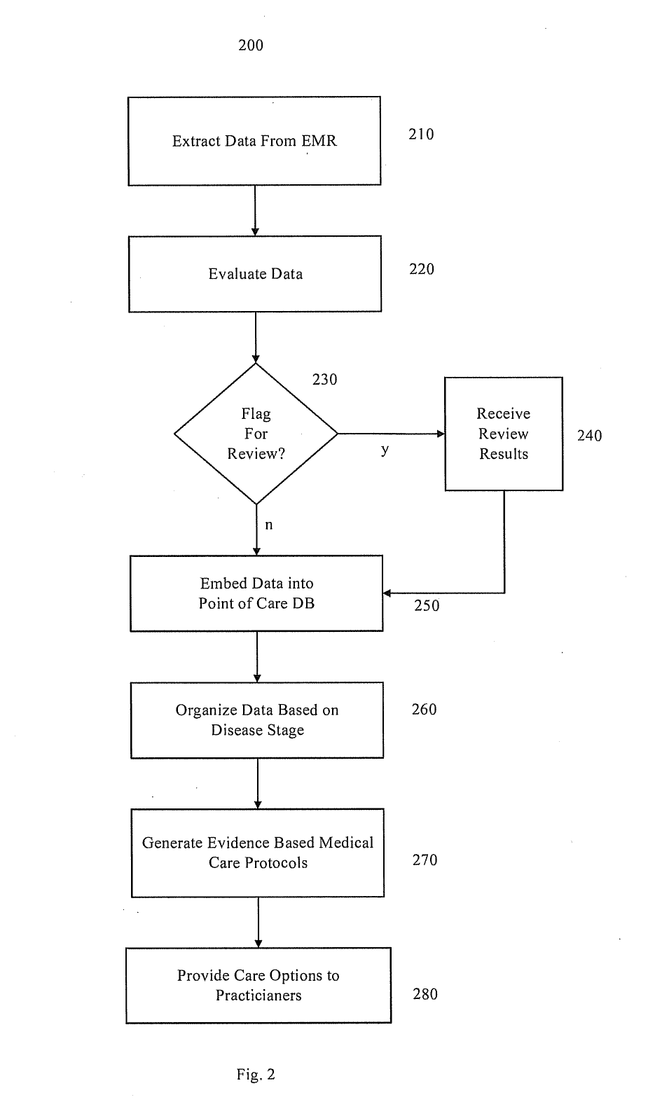

FIG. 2 is a medical care protocol generation process 200 according to an embodiment of the invention. This process 200 may generate evidence based medical care protocols and/or provide care options to medical care providers. The server 110 may extract data from the EHR 150. Data extracted from the EHR 150 may be patient information, such as information about a specific individual patient and/or specific disease or health information for the patient. Data extracted from the EHR 150 may also pertain to a group of patients and/or large samples of evidence-based data related to specific diseases or conditions. Extracted data may be evaluated 220, for example to identify specified clinical criteria. In the example presented herein, extracted data is evaluated for information relating to prostate cancer, although the server 110 may look for any type of data. In some cases, data may be flagged for review 230. If so, the server 110 may send the data to a user for review and await results of the review 240. When results are received, the results and/or data may be stored 250 in the point of care database 140. If no review is to be performed, the data may be automatically stored 250 in the point of care database 140.

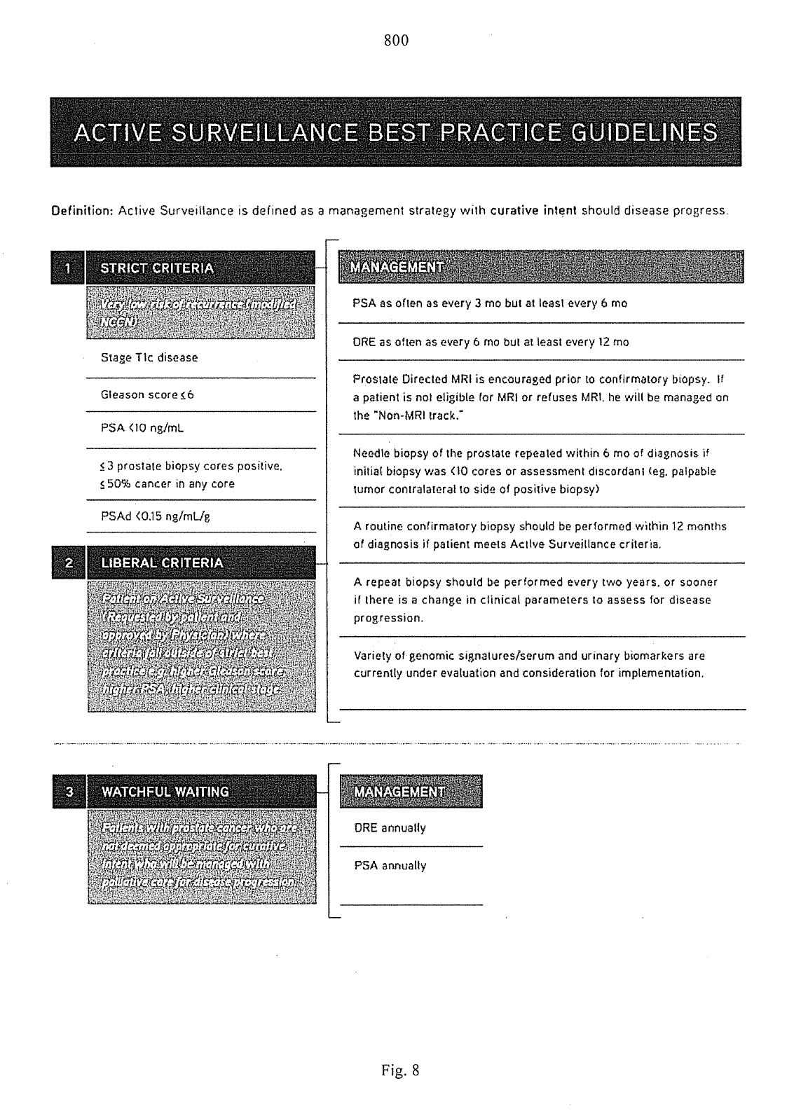

Flagging may be based on a variety of criteria. For example, some patients may be monitored under active surveillance. Anyone out of window for certain tests that are recommended to be performed (e.g., for ADT database imaging or PSA frequency based on stage of disease) may be flagged. Patients that meet strict criteria based on, for example, number of positive biopsy cores, Gleason score, % positive cores, etc. or patients that do not qualify for strict criteria flagging but who have elected for active surveillance (liberal criteria) may be identified. The treatments for these patients may be cross-referenced against CPT codes for treatment. Once patients have been identified as either strict or liberal they may be classified as described below. Anyone outside of this may be flagged for review. For an example of a report 800 including active surveillance criteria and management options, see FIG. 8.

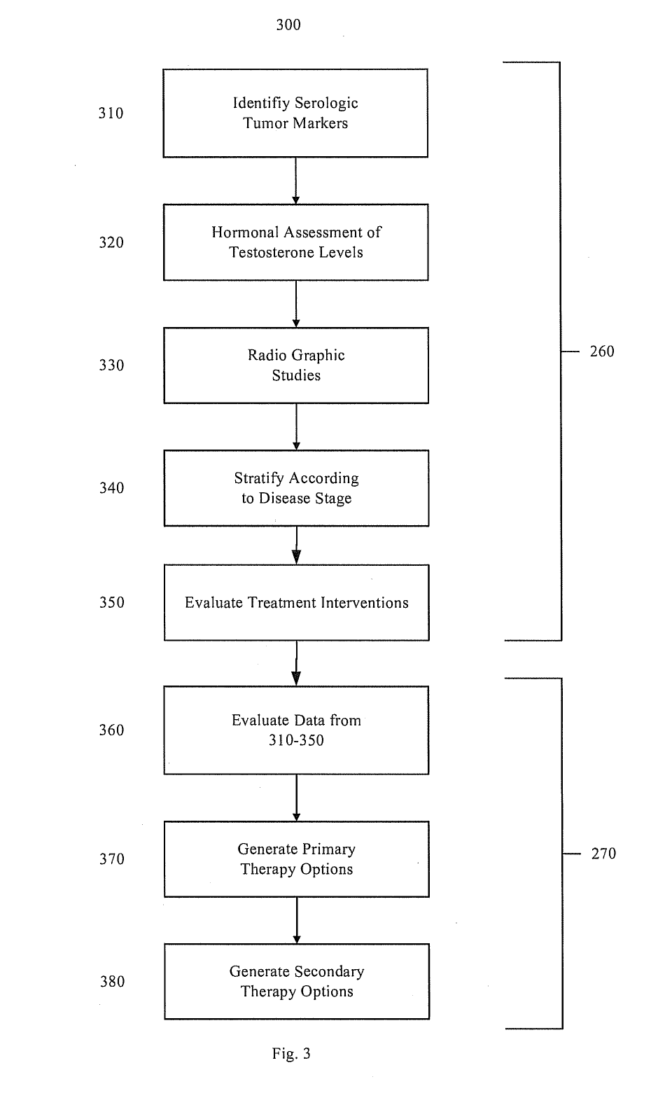

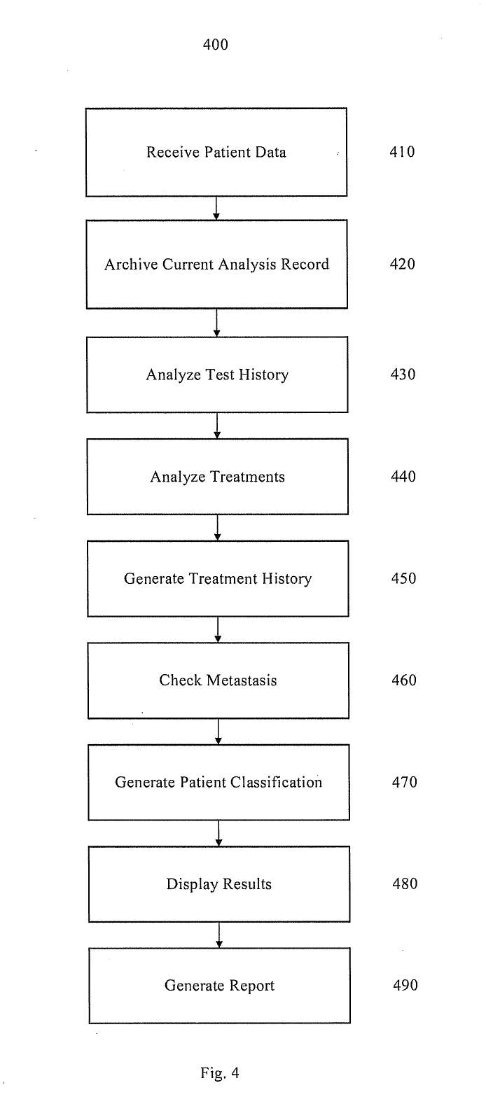

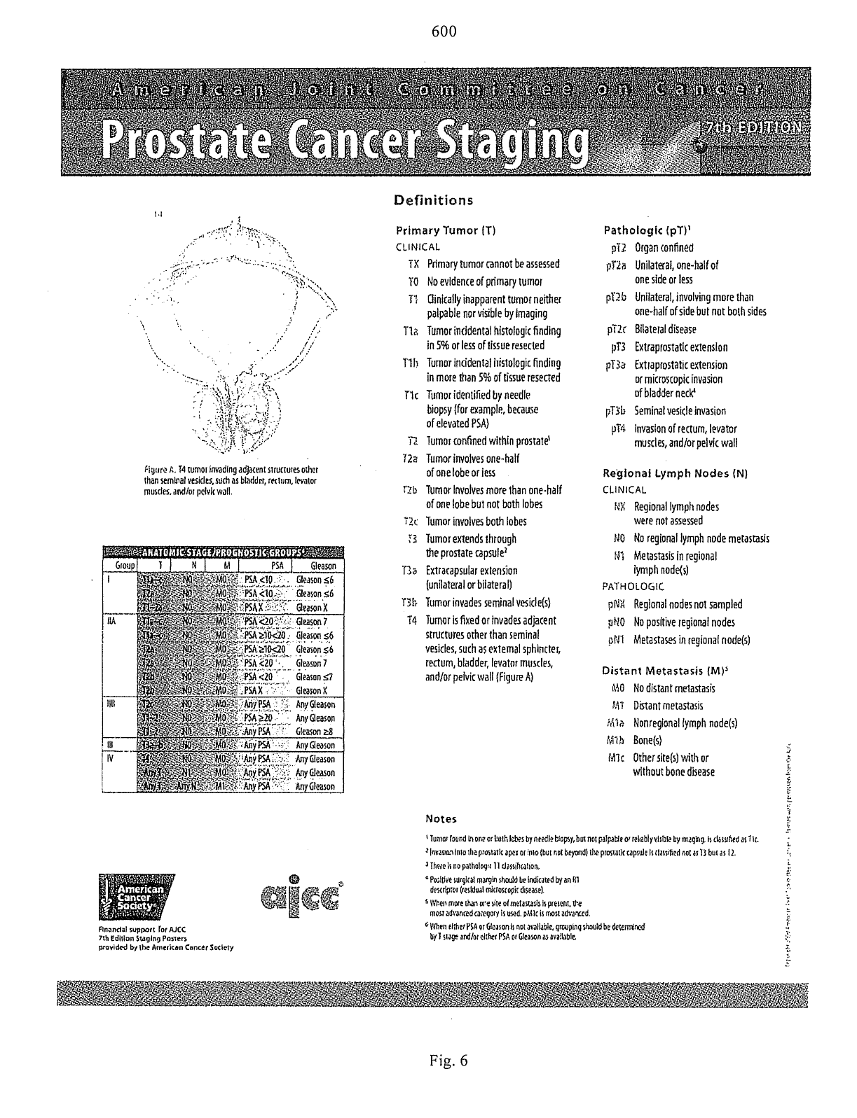

The data/results may be organized based on disease stage 260. FIG. 6 is a description 600 of prostate cancer staging and the pathologic stage of tumor at each stage according to an embodiment of the invention. This description 600 presents an example of definitions and information which may be used to organize prostate cancer based on stage. The stage may be defined by the American Joint Committee on Cancer (AJCC) tumor/node/metastasis (TNM) system. Returning to FIG. 2, the organized data may be evaluated by the server 110 to generate evidence based medical care protocols 270. A specific example in the context of prostate cancer is provided with respect to FIG. 3 below. A further example generating results for specific patients in the context of prostate cancer is provided with respect to FIG. 4 below. When the medical care protocols have been generated, they may be provided as treatment options to practitioners 280. For example, the treatment options may be transmitted to a client computer 170 in a doctor's office, and the doctor may consult with the patient whose data was extracted from the EHR 150 at the start of the process 200. While this example relates to prostate cancer, disease staging may be applied to a variety of medical conditions including but not limited to neoplastic diseases, cardiopulmonary diseases, endocrine diseases, renal diseases, gastrointestinal diseases, and organ transplantation.

FIG. 3 is a treatment option generation process 300 according to an embodiment of the invention. This process 300 may be a subset of the process 200 of FIG. 2, specifically involving data organization 260 and protocol generation 270. Organization based on disease stage 260 may be performed by evaluating one or more factors associated with a specific disease. In the prostate cancer example, staging may be determined by identifying serologic tumor markers 310, hormonal assessment of testosterone levels 320, radiographic studies 330, stratifying according to disease stage 340, and/or evaluating treatment interventions 350.

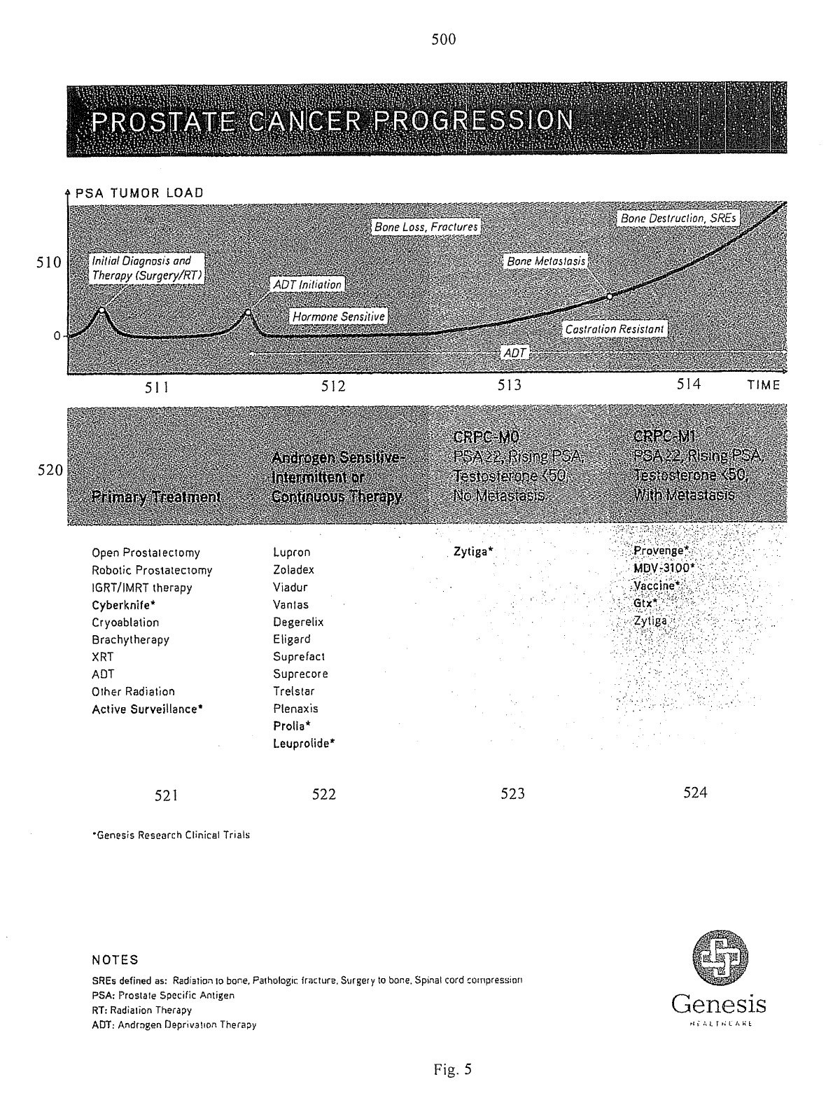

For example, a serologic tumor marker may be a Prostate Specific Antigen (PSA) which may graphically provide a snapshot of the disease status, as discussed further with respect to FIG. 5 below. Hormonal assessment of testosterone levels may be used to assess tumor response to therapy and adequacy of therapy. Examples may include differentiation of tumor stage—androgen sensitive versus castration-resistant prostate cancer (CRPC) and/or castrate levels of testosterone to ensure optimum reduction of testosterone to castrate levels. Radiographic studies may include technetium bone scans, sodium fluoride positron emission tomography—computed tomography (PET-CT) bone scans, computerized axial tomographic scans, positron emission technology scans, and/or magnetic resonance imaging scans. Treatment interventions may include past treatments, such as primary therapies (e.g., surgery, radiation therapy, cryotherapy, high-intensity focused ultrasound (HIFU), hormonal therapy) and/or secondary therapies (e.g., radiation therapy, surgery, hormonal therapy, immunotherapy, and chemotherapies).

The identified data (e.g., serologic tumor markers 310, hormonal assessment of testosterone levels 320, radiographic studies 330, disease stage stratification 340, and/or treatment interventions 350) may be evaluated 360, and primary and secondary treatment options may be generated 370, 380 based on the disease stage indicated by the data. FIG. 5 is diagram 500 of prostate cancer progression and recommended options for treatment according to stage as a function of PSA reflected tumor load according to an embodiment of the invention. This diagram 500 presents an example of a report including information about the disease stage and the treatment options. This diagram 500 may be a snapshot including an integrated historical overview of a patient's medical history pertaining to a specific disease (e.g., prostate cancer, chronic renal disease, etc.). Using icons, extensive lab results, radiographic studies, etc., treatment history may readily be accessed. The snapshot may provide a forum for rapid information processing by the treating physician. Treatment options (i.e., knowledge) can be embedded at point of care. One or more factors indicating disease stage may be shown. For example, a graphic image of the patient's PSA profile 510 is included in the diagram 500. The PSA profile 510 may indicate whether the disease has been cured, is in remission, or demonstrates evidence of progression. Other staging data may be included as well. For example, radiographic studies may be embedded into the graphic display 500, facilitating rapid access to the studies. The data displayed may include a combination of information from the point of care database 140 and information stored in the EHR database 150.

The server 110 may use the identified data to define a stage. In the example of FIG. 5, stage is defined according to pathologic stage according AJCC TNM staging system and treatment sensitive stage according to whether or not the tumor is sensitive to androgen depravation therapy (ADT)—ADT sensitive or resistant to ADT therapy—CRPC. In the prostate cancer example, stage I 511 generally indicates that the tumor is considered to be organ confined (i.e., in the prostate only) and amenable to ablative therapies including but not limited to surgery, /radiation, and other primary management therapies including but not limited to active surveillance, watchful waiting and focal therapies such as antineoplastic medications, LASER therapy, and cryotherapy. Stage II 512 generally indicates that the tumor continues to progress following primary therapy based on a rising PSA without (M0) or with (M1) metastatic disease. Stage II tumors are generally considered ADT sensitive and treated with ADT. Stage III/IV generally indicates a tumor that has become refractory to ADT therapy by virtue of a rising PSA level or radiographic evidence of disease progression despite castrate levels of testosterone (CRPC) (<50 ng/ml). Patients may be undefined CRPC when information regarding metastatic disease status is uncertain or M0 CRPC (absence of metastatic disease) or M1 CRPC (presence of metastatic disease). Defining the disease stage may allow for rapid and efficient tracking of specific disease stages for a patient and identification of specific therapeutic interventions for the patient.

The server 110 may make recommendations for appropriate treatments according to disease stage and display them 520. For example, primary treatments 521, androgen sensitive intermittent or continuous therapies 522, CRPC-M0 treatments 523, and CRPC-M1 treatments 524 may be presented for a prostate cancer analysis. In addition to the staging report 500 of FIG. 5, active surveillance best practice guidelines 800 may be presented, as shown in FIG. 8, for example when a patient has been identified for active surveillance as described above.

The same process 200 may be used to generate displays 500 for other medical conditions. Physicians may be provided with evidence based medical care protocols for management of any medical condition according to evidence based standards. Furthermore, additional data may be integrated into the example prostate cancer case. For example, bone health protocols pertinent to the management of advanced prostate cancer with ADT may be integrated into the EMR to ensure the provision/support of evidence based medical care protocols for disease management. according to evidence based standards. Embedding evidence based knowledge at the point of care can be applied to medical conditions including but not limited to heart failure, asthma, dyslipidemia, and other malignancies.

FIG. 4 is a classification and reporting process 400 according to an embodiment of the invention. The server 110 may also be used to generate a report for a specific patient or patients. Patients may be stratified according to stage of disease in order to select and organize patients into groups for management of their condition according to stage of the condition. For example, advanced prostate cancer can be divided into hormone sensitive (non-metastatic and metastatic) as well CRPC, which can be further divided into: undefined—where data is lacking to accurately stage the disease because PSA or testosterone levels are unknown; M0—patient has PSA greater than or equal to 2, PSA is rising, testosterone level is less than 50 and no metastasis; and M1—patient has PSA greater or equal to 2, PSA is rising, testosterone level is less than 50 with metastasis. Stratifying patients according to stage may allow appropriate treatment application based on prior clinical research. Automated stratification may enhance the accuracy of disease stratification, allow for earlier and appropriate therapeutic management, and thereby improve patient care.

Patient data may be received 410. For example, patient data may be entered into a client computer 170 and sent to the server 110 or may be extracted from a database 140-160. In some cases, patient data may be entered using a scantron form, which may be read by a client computer 170 or the server 110, and the data contained within the scantron form may be received 410 by the server, 110. The current patient data received by the server 110 may be archived 420, for example in the local database 130. The data may be analyzed. In the prostate cancer example, test histories 430 and treatments 440 may be analyzed. Testosterone test history may be analyzed 430 such that if there are no tests on file, the lack of tests may be noted in the remarks of a final report (described below) and the analysis may continue to treatment analysis 440, but if tests are on file, the latest test may be checked to determine if the score is less than 50. If the score is less than 50, a flag may be set, and if the latest test is more than two years old, this may be noted in the remarks. ADT treatment analysis 440 may be performed, wherein all ADT treatments on file may be reviewed and if any treatments are missing or there are no tests on file, this may be noted in the remarks. If there are tests on file, the date of last treatment may be checked to determine if the last treatment is past 30 days old as determined by calculating the dosage and type of treatment, and if the treatment is past 30 days old, this may be noted in the remarks. If the treatment is not past 30 days old, it may be flagged as active. Note that the specific tests, values, ages, etc. in these analyses 430, 440 are examples only. Other tests and treatments may be analyzed, other factors may be considered for other medical conditions, and/or other values may be of interest.

After analysis, a treatment history may be generated 450. This may include creating a table that stores times of continuous treatment of a patient. In the prostate cancer example, all ADT treatments may be analyzed for time and dosage to determine if there were any gaps in the treatment such that all values are stored and available for use in the remainder of the process. PSA tests may also be examined chronologically beginning with most recent. In some embodiments if there are less than three PSA tests, this may be noted in the remarks. All PSA tests taken may be reviewed such that if any of the PSA values are greater than 2 during treatment, the PSA level may be flagged as above 2. The rise of PSA levels may be checked by calculating the interpolated testosterone level for the date of the PSA test being reviewed such that if the PSA is rising and the patient was under treatment at the time, the rise may be considered valid. If there are at least two consecutive rises, the PSA level may be flagged and the testosterone level may be recorded such that if the interpolated testosterone level is less than 50, there are at least two consecutive rises, and the PSA value is flagged as greater than 2, the patient may be labeled castrate resistant (CRPC). Note that the specific tests, values, ages, etc. in the treatment history 450 are examples only. Other history data may be analyzed, other factors may be considered for other medical conditions, and/or other values may be of interest.

When the treatment history is built, metastasis may be checked 460, for example by reviewing the radiographic tests table to determine if the patient has radiographic metastasis set to “true.” If radiographically metastatic is set to “true” the patient may be flagged as metastatic. For other conditions, other factors may be checked.

With the data assembled as described above, the server 110 may analyze the assembled data to generate a patient classification 470. For example, if the patient was ever being treated with ADT and never had two consecutive rises in PSA, the patient may be classified as Androgen Sensitive. In the alternative, if a patient was flagged with testosterone levels less than 50, a PSA above 2, and at least two consecutive PSA rises, the patient may be labeled as M1 CRPC if they are metastatic or M0 CRPC if they are not metastatic. Other patients may be classified as undefined when data is insufficient to accurately stage the disease. As part of this analysis, the server 110 may identify specific treatment protocols based on stage, which may be presented to medical care providers (e.g., in an analysis report as described in greater detail below).

The server 110 may display the results of the classification 480. For example, these may be displayed on a local monitor and/or sent to a client 170 for display on a client monitor or printout. Diagnostic studies and therapeutic interventions may be annotated by icons, which upon clicking may open a file with details of the study or therapy (e.g., the analysis report described below). Access to chronologically embedded information may facilitate rapid access to information, creating the ability to rapidly access/appreciate the trend of the medical condition over time. The established disease trend may provide information based upon which further diagnostic studies or treatment options may be selected.

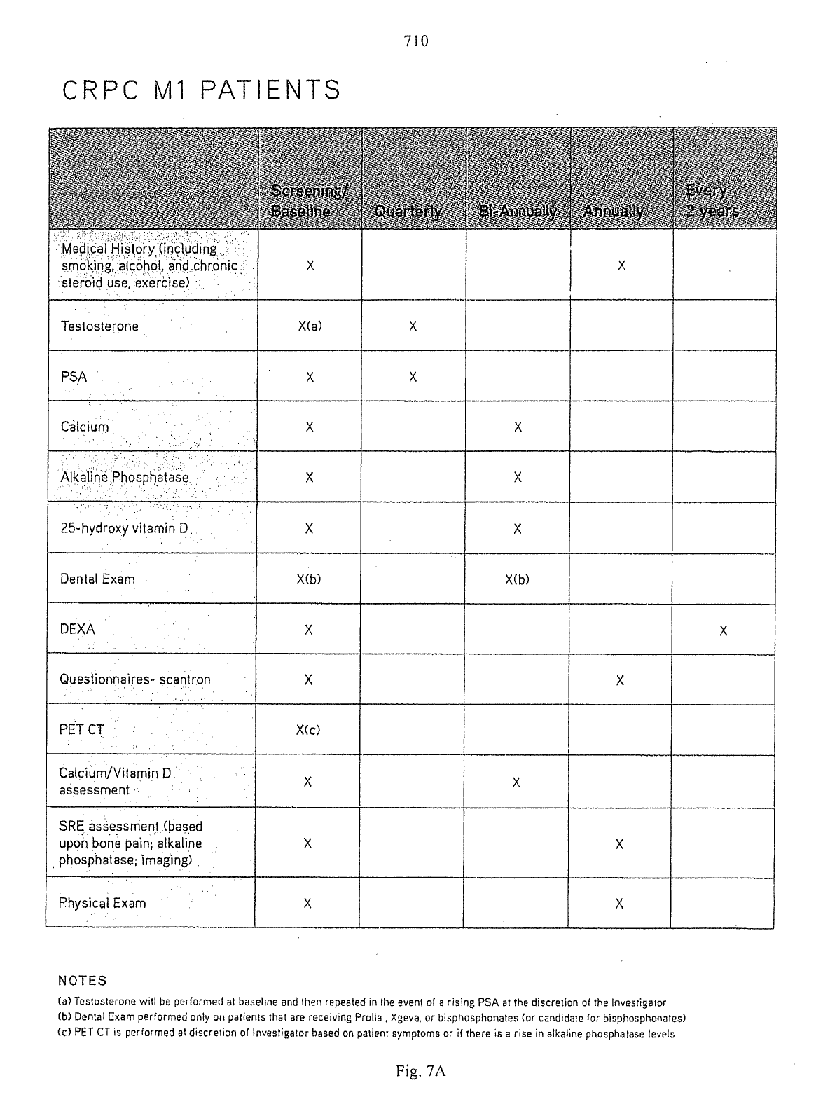

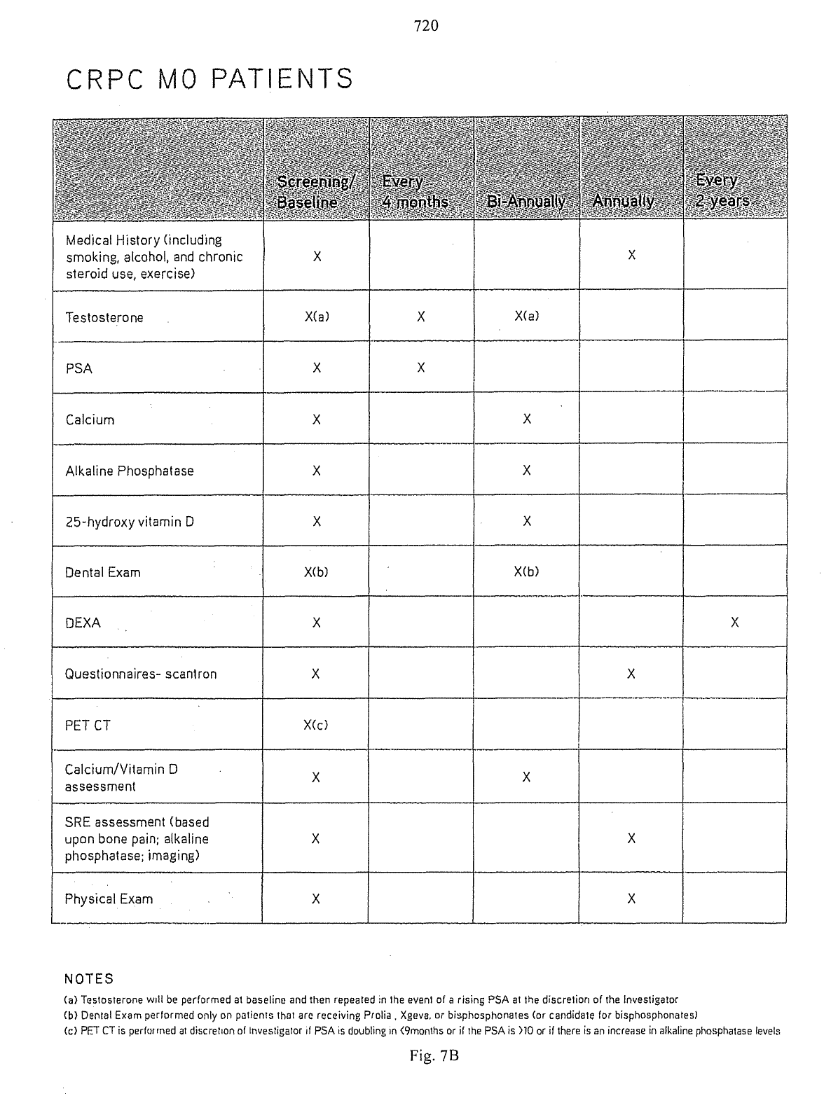

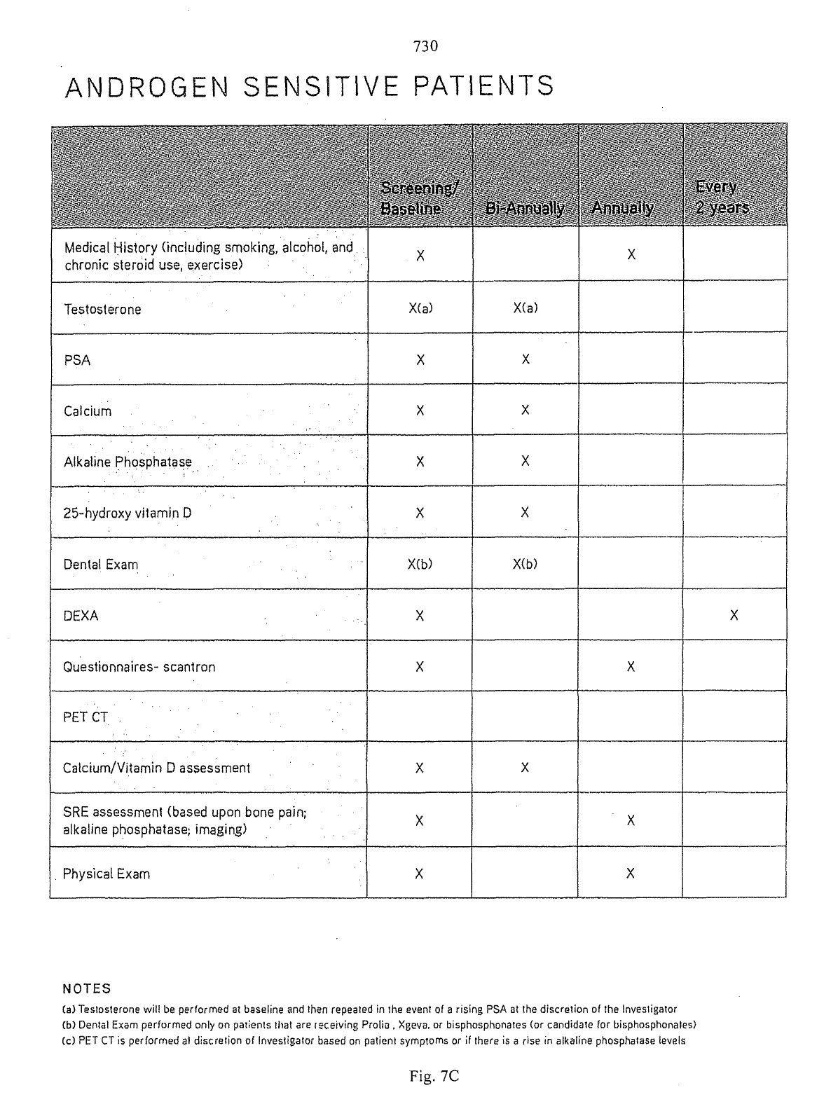

The server 110 may also generate an analysis report 490 to produce a formatted view of the patient analysis. This may also be sent to the client 170 for display on a client monitor or printout. FIGS. 7A-7C are sample reports 710-730 for patients with specific classifications according to an embodiment of the invention. The reports may include treatment protocols generated for the patients by the server 110 based on their classification. FIG. 7A is a sample report 710 including a treatment protocol for a patient classified as androgen sensitive, implying that the tumor remains sensitive to hormonal therapy (testosterone levels are lowered to castrate levels defined as <50 ng/ml). FIG. 7B is a sample report 720 including a treatment protocol for a patient classified as castrate resistant prostate cancer without demonstrable metastatic disease (CRPC M0). FIG. 7C is a sample report 730 including a treatment protocol for a patient classified as castrate resistant prostate cancer with demonstrable metastatic disease (CRPC MD. The sample treatment protocols may provide standards of care for patients at each stage of prostate cancer, including but not limited to follow-up screenings which are recommended and the time frame at which each screening is recommended to be performed. These protocols may be associated with specific patients. Thus, they may serve as a protocol filter in which inclusion/exclusion criteria specific for a clinical trial may help expedite patient recruitment from large patient cohorts. Patients may be grouped according to the protocols applied to them, and clinical researchers may be able to access these groups. This may allow for expeditious patient identification for clinical trials as well as improved efficiency in the review process by physicians and research coordinators of potential patients.

The classification and treatment generation systems and methods described above may generate a great deal of data which is stored in the local database 130. It will be apparent to those skilled in the art that this data may be aggregated and used for assessment of clinical practice standards and identification of potential patients for clinical trials. Accordingly, the server 110 may also be configured to generate clinical practice and clinical trial reports from the data and distribute them to appropriate parties. In some embodiments, the server 110 may mark patients associated with the data as being suitable for a particular trial based on the analysis performed as described above, e.g., while generating the report 490 or instead of generating the report 490.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, while some examples herein are presented in the context of prostate cancer analysis and treatment, it will be understood that the systems and methods described herein can be applied to other diseases and treatments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A medical analysis method comprising:
receiving, at a server comprising a processor circuit and a database, medical data;
identifying, with the processor circuit, data indicative of a disease stage within the medical data;
storing, with the processor circuit, the data indicative of the disease stage in the database;
organizing, with the processor circuit, the data indicative of the disease stage based on disease stage;
analyzing, with the processor circuit, the data indicative of the disease stage to generate a treatment option based on the disease stage; and
causing, with the processor circuit, the treatment option and the organized data to be displayed.

2. The method of claim 1, wherein the medical data comprises data extracted from an electronic health record (EHR) database.

3. The method of claim 2, further comprising extracting, with the processor circuit, the medical data from the EHR database via a network.

4. The method of claim 1, wherein the medical data comprises data associated with a specific patient.

5. The method of claim 4, wherein the medical data is received from a client computer via a network.

6. The method of claim 1, wherein identifying data indicative of a disease stage within the medical data comprises:
flagging at least a portion of the medical data for review; and
receiving results of a review indicating whether the portion of the medical data is indicative of a disease stage.

7. The method of claim 1, wherein organizing the data indicative of the disease stage based on disease stage comprises evaluating the data indicative of the disease stage to identify a factor associated with the disease stage.

8. The method of claim 7, wherein the factor includes test results, indicator levels, radiographic studies, treatment interventions, or a combination thereof.

9. The method of claim 7, wherein analyzing the data indicative of the disease stage to generate a treatment option based on the disease stage comprises analyzing the factor to identify a treatment option associated with the factor.

10. The method of claim 1, wherein causing the treatment option and the organized data to be displayed comprises generating a report including the treatment option and the organized data.

11. The method of claim 10, wherein the report comprises a disease status snapshot.

12. The method of claim 10, wherein the report comprises an active surveillance report.

13. The method of claim 1, wherein causing the treatment option and the organized data to be displayed comprises sending the treatment option and the organized data to a client computer via a network.

14. The method of claim 1, wherein the treatment option comprises a treatment protocol based on the disease stage.

15. The method of claim 1, further comprising:
grouping, with the processor circuit, a plurality of patients associated with the medical data based on the treatment option and/or the organized data; and
storing, with the processor circuit, the grouping in the database.

16. A medical analysis system comprising:
a database; and
a processor circuit in communication with the database, the processor circuit configured to:
receive medical data;
identify data indicative of a disease stage within the medical data;
store the data indicative of the disease stage in the database;
organize the data indicative of the disease stage based on disease stage;
analyze the data indicative of the disease stage to generate a treatment option based on the disease stage; and
cause the treatment option and the organized data to be displayed.

17. The system of claim 16, wherein the medical data comprises data extracted from an electronic health record (EHR) database.

18. The system of claim 17,wherein the processor circuit is further configured to extract the medical data from the EHR database via a network.

19. The system of claim 16, wherein the medical data comprises data associated with a specific patient.

20. The system of claim 19, wherein the medical data is received from a client computer via a network.

21. The system of claim 16, wherein the processor circuit is configured to identify data indicative of a disease stage within the medical data by:
flagging at least a portion of the medical data for review; and
receiving results of a review indicating whether the portion of the medical data is indicative of a disease stage.

22. The system of claim 16, wherein the processor circuit is configured to organize the data indicative of the disease stage based on disease stage by evaluating the data indicative of the disease stage to identify a factor associated with the disease stage.

23. The system of claim 22, wherein the factor includes test results, indicator levels, radiographic studies, treatment interventions, or a combination thereof.

24. The system of claim 22, wherein the processor circuit is configured to analyze the data indicative of the disease stage to generate a treatment option based on the disease stage by analyzing the factor to identify a treatment option associated with the factor.

25. The system of claim 16, wherein the processor circuit is configured to cause the treatment option and the organized data to be displayed by generating a report including the treatment option and the organized data.

26. The system of claim 25, wherein the report comprises a disease status snapshot.

27. The system of claim 25, wherein the report comprises an active surveillance report.

28. The system of claim 16, wherein the processor circuit is configured to cause the treatment option and the organized data to be displayed by sending the treatment option and the organized data to a client computer via a network.

29. The system of claim 16 wherein the treatment option comprises a treatment protocol based on the disease stage.

30. The system of claim 16, wherein the processor circuit is further configured to:
group a plurality of patients associated with the medical data based on the treatment option and/or the organized data; and
store the grouping in the database.

31. A medical analysis method comprising:
receiving, at a server comprising a processor circuit and a database, medical data;
identifying, with the processor circuit, data indicative of a disease stage within the medical data;
storing, with the processor circuit, the data indicative of the disease stage in the database;
organizing, with the processor circuit, the data indicative of the disease stage based on disease stage;
analyzing, with the processor circuit, the data indicative of the disease stage to determine whether a patient associated with the medical data is eligible for a clinical study based on the disease stage; and
flagging, with the processor circuit, the patient as eligible for the clinical study.

32. The method of claim 31, wherein the medical data comprises data extracted from an electronic health record (EHR) database.

33. The method of claim 32, further comprising extracting, with the processor circuit, the medical data from the EHR database via a network.

34. The method of claim 31, wherein the medical data comprises data associated with a specific patient.

35. The method of claim 34, wherein the medical data is received from a client computer via a network.

36. The method of claim 31, further comprising:
grouping, with the processor circuit, a plurality of patients associated with the medical data based on the flagging and/or the organized data; and
storing, with the processor circuit, the grouping in the database.

37. A medical analysis system comprising:
a database; and
a processor circuit in communication with the database, the processor circuit configured to:
receive medical data;
identify data indicative of a disease stage within the medical data;
store the data indicative of the disease stage in the database;
organize the data indicative of the disease stage based on disease stage;
analyze the data indicative of the disease stage to determine whether a patient associated with the medical data is eligible for a clinical study based on the disease stage; and
flag the patient as eligible for the clinical study.

38. The system of claim 37, wherein the medical data comprises data extracted from an electronic health record (EHR) database.

39. The system of claim 38,wherein the processor circuit is further configured to extract the medical data from the EHR database via a network.

40. The system of claim 37, wherein the medical data comprises data associated with a specific patient.

41. The system of claim 40, wherein the medical data is received from a client computer via a network.

42. The system of claim 42, wherein the processor circuit is further configured to:
group a plurality of patients associated with the medical data based on the treatment option and/or the organized data; and
store the grouping in the database.
